(19) United States
(12) Patent Application Publication
(10) Pub. No.: US 2008/0270546 A1
(43) Pub. Date: Oct. 30, 2008

(54) Methods And Systems For Communicating Task Information

(76) Inventors: Robert P. Morris, Raleigh, NC (US); Robert J. Sundstrom, Cary, NC (US)

Correspondence Address: SCENERA RESEARCH, LLC, 111 CORNING RD., SUITE 220, CARY, NC, 27518, US

(21) Appl. No.: 11/742,153

(22) Filed: Apr. 30, 2007

(51) Int. Cl. G06F 15/16

(52) U.S. Cl. 709/206

(57) ABSTRACT

Methods, systems, and computer readable media are described for communicating task information. According to an aspect, a method includes receiving a publish message including task information representing a request, generating a notify message addressed to a device associated with the recipient watcher, wherein the notify message includes a sender presentity identifier, sending the notify message to the device enabling the task information to be presented with presence information associated with the sender presentity.

According to another aspect, a method includes presenting information associated with a watched presentity, the presented information including presence information of the watched presentity, receiving a notify message including task information representing a request, wherein the watched presentity is a presence agent of the sender, updating the presented information to include a task indicator based on the received task information, the task indicator presented with the presence information of the watched presentity.

### BACKGROUND

Making requests of others, particularly time sensitive tasks, typically takes place today through direct communication. For example, a phone call, an email, a person to person conversation, or a text message can be used to make a request of a user to perform a task. While many users have to-do or task lists, few users share the task lists. Even when task lists are shared, few users check the shared task lists often enough to pick up last minute additions or changes to their to-do lists.

Today's task list systems do not allow a requesting user to manage to-do lists or tasks for another user in a way that does not require access to the other user's traditional task list. Further, today's task list systems do not allow a requesting user to view the status of another user. Thus, today's task list systems do not provide a requesting user with the ability to communicate last-minute or near-term, time-sensitive tasks to users that the requesting user knows are available for performing the task.

Accordingly, there exists a need for methods, systems, and computer program products for communicating task information.

### SUMMARY

Methods, systems, and computer programs embodied in computer readable media are described for communicating task information. According to an aspect, a method for communicating task information is disclosed. The method includes receiving a publish message including task information representing a request for a principal associated with a recipient watcher to perform a task, the publish message associated with the recipient watcher and a sender presentity. The method also includes generating a notify message addressed to a device associated with the recipient watcher. The notify message is based on the task information and includes a sender presentity identifier. The method further includes sending the notify message to the device associated with the recipient watcher enabling the task information to be presented with presence information associated with the sender presentity.

According to another aspect, a system for communicating task information is disclosed. The system includes means for receiving a publish message including task information representing a request for a principal associated with a recipient watcher to perform a task. The publish message is associated with the recipient watcher and a sender presentity. The system includes means for generating a notify message addressed to a device associated with the recipient watcher. The notify message is based on the task information and includes a sender presentity identifier. The system further includes means for sending the notify message to the device associated with the recipient watcher, enabling the task information to be presented with presence information associated with the sender presentity.

According to another aspect, a system for communicating task information is disclosed. The system includes a publication handler component configured for receiving a publish message including task information representing a request for a principal associated with a recipient watcher to perform a task, the publish message associated with the recipient watcher and a sender presentity. The system also includes a notification handler component configured for generating a notify message addressed to a device associated with the recipient watcher, the notify message based on the task information and including a sender presentity identifier. The system further includes a message router component configured for sending the notify message to the device associated with the recipient watcher enabling the task information to be presented with presence information associated with the sender presentity.

According to another aspect, a computer readable medium including a computer program, executable by a machine, for communicating task information is disclosed. The computer program includes executable instructions for receiving a publish message including task information representing a request for a principal associated with a recipient watcher to perform a task, the publish message associated with the recipient watcher and a sender presentity. The computer program also includes executable instructions for generating a notify message addressed to a device associated with the recipient watcher, the notify message based on the task information and including a sender presentity identifier. The computer program further includes executable instructions for sending the notify message to the device associated with the recipient watcher enabling the task information to be presented with presence information associated with the sender presentity.

According to another aspect, a method for communicating task information is disclosed. The method includes presenting information associated with a watched presentity, the presented information including presence information of the watched presentity. The method also includes receiving a notify message including task information representing a request for a principal associated with a recipient watcher to perform a task from a sender, wherein the watched presentity is a presence agent of the sender. The method further includes updating the presented information to include a task indicator based on the received task information, the task indicator presented with the presence information of the watched presentity.

According to another aspect, a system for communicating task information is disclosed. The system includes means for presenting information associated with a watched presentity. The presented information includes presence information of the watched presentity. The system also includes means for receiving a notify message including task information representing a request for a principal associated with a recipient watcher to perform a task from a sender. The watched presentity is a presence agent of the sender. The system further includes means for updating the presented information to include a task indicator based on the received task information. The task indicator presented with the presence information of the watched presentity.

According to another aspect, a system for communicating task information is disclosed. The system includes a user interface component configured for presenting information associated with a watched presentity, the presented information including presence information of the watched presentity. The system also includes a watcher component configured for receiving a notify message including task information representing a request for a principal associated with a recipient watcher to perform a task from a sender, wherein the watched presentity is a presence agent of the sender. The user interface component is further configured for updating the presented information to include a task indicator based on the received task information, the task indicator presented with the presence information of the watched presentity.

According to another aspect computer readable medium including a computer program, executable by a machine, for communicating task information is disclosed. The computer program includes executable instructions for presenting information associated with a watched presentity, the presented information including presence information of the watched presentity. The computer program also includes executable instructions for receiving a notify message including task information representing a request for a principal associated with a recipient watcher to perform a task from a sender, wherein the watched presentity is a presence agent of the sender. The computer program further includes executable instructions for updating the presented information to include a task indicator based on the received task information, the task indicator presented with the presence information of the watched presentity.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for communicating task information according to an embodiment of the subject matter described herein;

FIG. 2 is a block diagram illustrating a system for communicating task information according to another embodiment of the subject matter described herein;

FIG. 3 is a block diagram illustrating in greater detail a portion of the system for communicating task information illustrated in FIG. 2 according to another embodiment of the subject matter described herein;

FIG. 4 is a flow diagram illustrating a method for communicating task information according to another embodiment of the subject matter described herein;

FIG. 5 is a block diagram illustrating a system for communicating task information according to another embodiment of the subject matter described herein; and

FIG. 6 is a block diagram illustrating an exemplary user interface for communicating task information according to another embodiment of the subject matter described herein.

### DETAILED DESCRIPTION

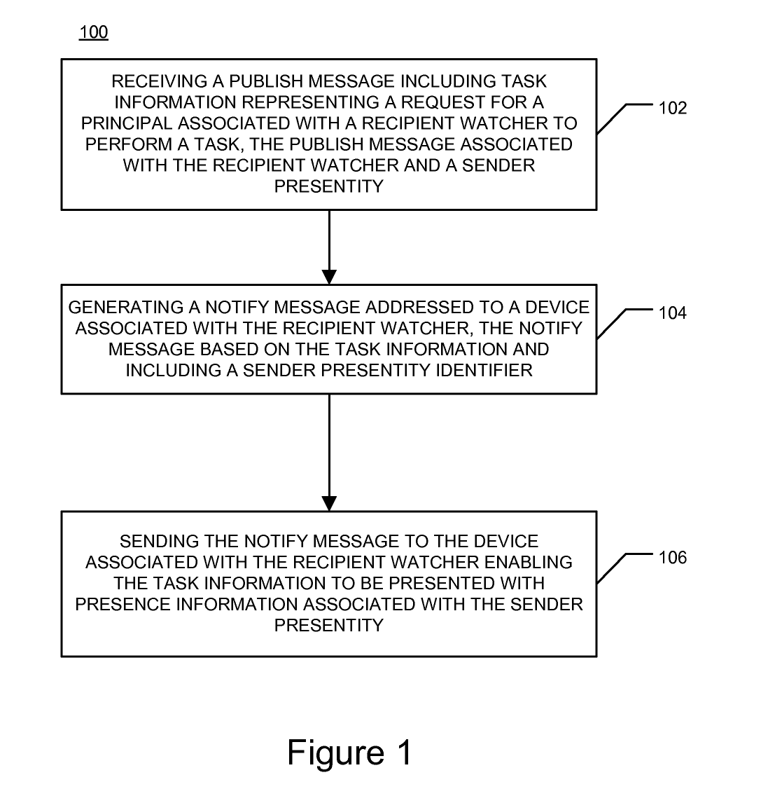

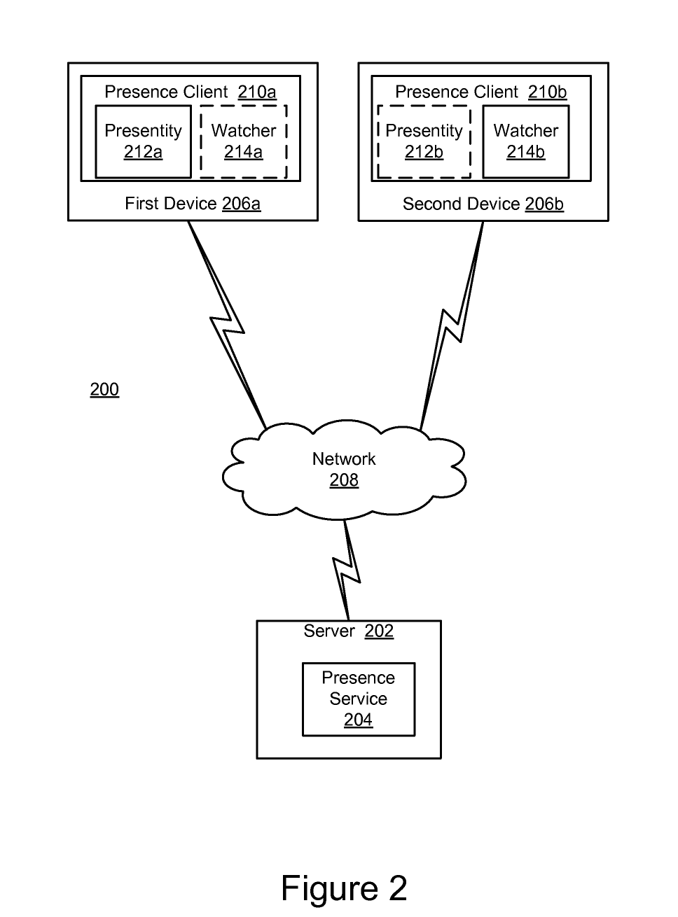

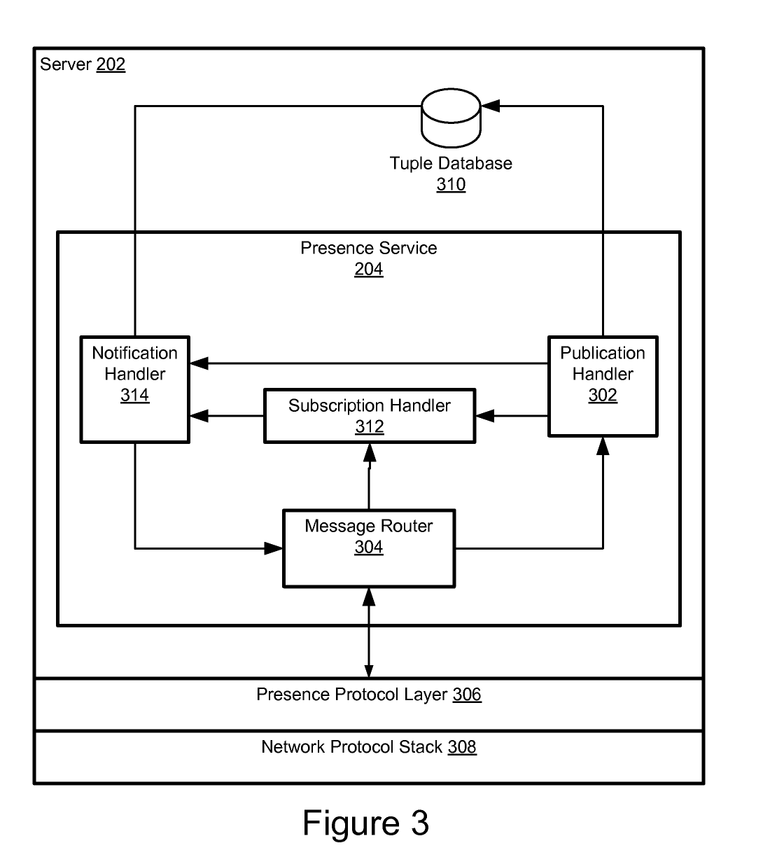

FIG. 1 is a flow diagram illustrating a method 100 for communicating task information according to an exemplary embodiment of the subject matter described herein. FIG. 2 is a block diagram illustrating a system 200 for communicating task information according to another exemplary embodiment of the subject matter described herein. FIG. 3 is a block diagram illustrating in greater detail a portion of the system for communicating task information illustrated in FIG. 2. The method illustrated in FIG. 1 can be carried out by, for example, some or all of the components illustrated in the exemplary system of FIG. 2 and further illustrated in FIG. 3.

With reference to FIG. 1, in block 102 a publish message including task information representing a request for a principal associated with a recipient watcher to perform a task is received. The publish message is associated with the recipient watcher and a sender presentity. Accordingly, a system for communicating task information includes means for receiving a publish message including task information representing a request for a principal associated with a recipient watcher to perform a task. The publish message is associated with the recipient watcher and a sender presentity. For example, as illustrated in FIG. 2, the system 200 includes a server 202 including a presence service 204. The server 202 is in communication with a first device 206a and a second device 206b via a network 208. As illustrated in FIG. 3, a publication handler component 302 is included in the presence service 204 in an embodiment. The publication handler component 302 is configured for receiving a publish message including task information representing a request for a principal associated with a recipient watcher to perform a task. The publish message is associated with the recipient watcher and a sender presentity.

Returning to FIG. 2, the first device 206a and the second device 206b each provide an operating environment for a first presence client 210a and a second presence client 210b, respectively. The presence clients 210 are capable of communicating with the presence service 204 running in an operating environment provided by the server 202 using a presence protocol transmitted via a network 208. Presence protocols are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society.

For example, the first presence client 210a can receive task information from a sending principal. The sending principal is represented to the presence service 204 by a presentity 212a and a watcher 214a. The task information includes task information associated with an intended recipient. For, example, the recipient can be a receiving principal that is associated with the presence client 210b. The recipient is represented to the presence service 204 by a presentity 212b and a watcher 214b included in the presence client 210b. When the first presence client 210a receives the task information, a publish message including the task information is transmitted from the first device 206a to the server 202 via the network 208 by a presentity 212a included in the presence client 210a.

In another aspect, the task information can include at least one of a task identifier representing a predefined task and a text string representing a task. For example, the task information can include a task identifier “MeetCR” that represents a predefined task of meeting in the conference room. Alternatively, the task information can include a text string, “Please meet me in the conference room in 5 minutes.” The text string represents a request for a principal to perform a task, namely meeting in the conference room. In another aspect, the task information can include time information representing a time period associated with the task. For example, the task information can include a timeout value of 10 minutes indicating the task is not valid 10 minutes after the time of publication.

A message router component 304 included in the presence service component 204 receives the publish message in an embodiment. The message router component 304 receives the publish message from a presence protocol layer 306 via a network protocol stack 308 included in the operating environment of the server 202. The message router component 304 routes messages based on message type. Message types can include, for example, a publish type, a subscribe type, or a notify type. Publish type messages are routed by the message router component 304 to the publication handler component 302.

A received publish message is associated with the presentity 212a based on information in the message identifying the publishing presentity and/or by an identifier in the message associating the task information with a tuple of the presence service 204. For example, the publish message can include presence information associated with the principal of the sender presentity 212a. According to an aspect, a presence tuple associated with the sender is updated in response to receiving the publish message. For example, the publication handler component 302 can be configured for updating a presence tuple associated with the sender in response to receiving the publish message. Thus, the message including the presence information and the task information is associated with the sending principal's presence tuple and the sender presentity 212a.

In the server 202, the publication handler component 302 can be configured to update a tuple associated with the sender presentity 212a identified in the publish message. The publication handler component 302 can create and update tuples in the server 202 in a tuple database 310 provided by the server 202. According to an aspect where task information is stored in a presence tuple associated with a presentity, such as the presentity 212a, the publication handler component 302 can update the presence tuple of the presentity 212a with the task information in the publish message. When a presence tuple does not exist for a presentity, a presence tuple can be created when a publish message is received from an authorized presentity.

According to an aspect where task information is stored in a presence tuple, if the task information is determined to be for an existing task, the task information in the presence tuple is updated with the task information in the publish message. If there is no existing task information corresponding to the task information in the presence tuple, then new task information is added to the presence tuple. In embodiments supporting other tuple structures, the processing of new task information and updated task information for existing tasks is functionally equivalent.

Example 1 depicts an exemplary presence tuple below. The exemplary presence tuple includes a task sub-tuple as identified by the “Task” element. The “Task” element can include one or more “Recipient” elements. Each “Recipient” element includes information identifying a recipient, typically using a presence identifier, and a task “Content” element. The “Content” element includes information identifying a task, such as a text string, a task ID for a pre-defined task, and/or a media representation of the task such as a voice message.

### EXAMPLE 1

```
+------------------------------------+
| PRESENCE INFORMATION |
+------------------------------------+
  | +-------------------------------+
  =>| PRESENCE TUPLE |
  | +-------------------------------+
  | | +-------------------------+
  | =>| STATUS |
  | | +-------------------------+
  | | +-------------------------+
  | =>| COMMUNICATION ADDRESS |
  | | +-------------------------+
  | | | +-----------------+
  | | =>| CONTACT MEANS |
  | | | +-----------------+
  | | | +-----------------+
  | | =>| CONTACT ADDRESS |
  | | +-----------------+
  | | +--------------------------+
  | =>| TASK TUPLE |
  | +--------------------------+
  | | | +--------------------+
  | | =>| RECIPIENT TUPLE |
  | | | +--------------------+
  | | | +-----------------+
  | | =>| RECIPIENT ID |
  | | | +-----------------+
  | | | +-----------------+
  | | =>| CONTENT TUPLE |
  | | | +-----------------+
  | | .
  | | .
  | | .
  | | +-------------------------+
  | =>| OTHER MARKUP |
  | +-------------------------+
  | +-------------------------------+
  =>| PRESENCE TUPLE |
  | +-------------------------------+
```

According to another aspect, a task tuple can be generated in response to receiving the publish message. The generated task tuple can include a sender element, a recipient element, and a task information element. For example, the publication handler component 302 can be configured for generating a task tuple in response to receiving the publish message. The task tuple can include a sender element, a recipient element, and a task information element. Once the task tuple, is generated, the recipient can be subscribed to the task tuple. For example, the system can include a subscription handler component 312 configured for subscribing the recipient to the generated task tuple.

Example 2 depicts a second exemplary tuple for task information below. Example 2 depicts a task tuple stored apart from sender tuple and the recipient tuple. The task tuple can be a presence tuple including a status element representing the status of the task. The tuple can be updatable by one or both of the sender and the recipient. A “Sender ID” element and a “Recipient ID” element include information identifying the sender of the task and the recipient respectively. The identifying information can be the presence identifiers of the sender and receiver associating the task with the presence tuples of the sender and the receiver. Example 2 illustrates a tuple for one task for exemplary purposes. According to an aspect, a task tuple can be a task list tuple that includes one or more task tuples. A task list tuple can be a presence tuple including an overall status and the included task tuples can include their own status element as previously indicated.

### EXAMPLE 2

+-------------------------+
| TASK TUPLE |
+-------------------------+
| | +-------------------------+
| =>| STATUS |
| | +-------------------------+
| | +-------------------------+
| =>| SENDER ID |
| | +------------------------+
| | +-------------------+
| =>| RECIPIENT ID |
| | +-------------------+
| | +----------------------+
| =>| CONTENT TUPLE |
| | +----------------------+
| | | +----------------------+
| | =>| DEADLINE/EXPIRATION |
| | | +----------------------+
| | | +----------------------+
| | =>| PRIORITY |
| | | +----------------------+
| | | +----------------------+
| | =>| TASK ID |
| | | +----------------------+
| | | +----------------------+
| | =>| OTHER |
| | | +----------------------+

According to an aspect, a friends list tuple associated with the sender can be updated in response to receiving the publish message. For example, the publication handler component 302 can be configured for updating a friends list tuple associated with the sender in response to receiving the publish message. Example 3 depicts a third exemplary tuple for task information below. The tuple in Example 3 represents a friends list including a list of identifiers of presence tuples watched by a principal associated with a presence tuple that references the friends list tuple. The friends list tuple in Example 3 associates each “Friend ID” element with a “Task List” element, such as the task list tuple just discussed. A task list tuple contains task elements for each task the owner of the friends list has sent as a request to perform the task to the associated friend. According to an aspect, a task tuple in a task list tuple can include a request to perform a task sent by the principal associated with the presence tuple that owns the friends list. A task request can be stored in a task list tuple associated with a friend identified by a Friend ID that receives the task information.

### EXAMPLE 3

```
+------------------------------------+
| FRIENDS LIST TUPLE |
+------------------------------------+
  | +-------------------------------+
  =>| FRIEND TUPLE |
  | +-------------------------------+
  | | +-------------------------+
  | =>| FRIEND ID |
  | | +-------------------------+
  | | +-------------------------+
  | =>| TASK LIST TUPLE |
  | | +-------------------------+
  | | | +-----------------+
  | | =>| TASK TUPLE |
  | | | +-----------------+
  | | .
  | | .
  | | .
  | | +-------------------------+
  | =>| FRIEND ID |
  | | +-------------------------+
  | .
  | .
  | .
```

Returning to FIG. 1, in block 104 a notify message addressed to a device associated with the recipient watcher is generated. The notify message is based on the task information and includes a sender presentity identifier. Accordingly, a system for communicating task information includes means for generating a notify message addressed to a device associated with the recipient watcher. For example, as illustrated in FIG. 3, a notification handler component 314 is configured for generating a notify message addressed to a device associated with the recipient watcher. The notify message is based on the task information and includes a sender presentity identifier.

The notification handler component 314 generates a notify message addressed to a device, such as second device 206b associated with the recipient watcher, such as the recipient watcher 214b. The notify message is based on the task information and includes an identifier of the sender presentity, for example, the identifier of the presence tuple associated with the presentity 212a. In another aspect, generating a notify message includes identifying address information for the device associated with the recipient watcher. For example, the notification handler component 314 can be configured for identifying address information for the device associated with the recipient watcher based on the association between the task information and the recipient.

For example, the publish message sent from presentity 212a, representing the sending principal, can include the receiving principal's presence identifier. The publication handler component 302 can interpret the publish message as a directed publish. As a result, the publication handler component 302 sends the notification handler component 314 a representation of at least a portion of the publish message including the task information. The task information includes the receiving principal's presence identifier. The notification handler component 314 can determine the address of the recipient watcher 214b by locating the receiving principal's presence tuple using the receiving principal's presence identifier and retrieving the receiving principal's presence contact address. The receiving principal's presence contact address can include the network address of the second device 206b that hosts the recipient watcher 214b. The notification handler component 314 can use the contact address information to address the message to the second device 206b. The message can include additional address information, such as a port number, enabling the notify message to be routed to the watcher 214b.

According to an aspect using a separate task tuple as illustrated above in Example 2, the publish message is processed by the publication handler component 302 as a normal publish message. When a task tuple associated with the received task information is created and/or updated, the publication handler component 302 invokes a subscription handler component 312 for processing subscriptions, if any, associated with the task tuple. As discussed above, when a task tuple is created, the identified recipient is automatically subscribed to the task tuple for receiving notifications related to the creation and updates to the task tuple. The sender of the task information can also be automatically subscribed to the task tuple. The subscription handler component 312 can retrieve a subscription list stored in the tuple database 310. For each subscriber in the subscription list, the subscription handler component 312 invokes the notification handler component 314. The notification handler component 314 generates a notify message, as described above, addressed to a device associated with a watcher of the subscriber. The generated message includes the task information and an identifier of the sender presentity.

Returning to FIG. 1, in block 106 the notify message is sent to the device associated with the recipient watcher enabling the task information to be presented with presence information associated with the sender presentity. Accordingly, a system for communicating task information includes means for sending the notify message to the device associated with the recipient watcher enabling the task information to be presented with presence information associated with the sender presentity. For example, as illustrated in FIG. 3, a message router component 304 is configured for sending the notify message to the device associated with the recipient watcher enabling the task information to be presented with presence information associated with the sender presentity.

As discussed above, the presence service 204 includes the notification handler component 314 for generating the notify message. The notification handler component 314 invokes the message router component 304 and passes the generated notify command and address information associated with the device, second device 206b, of the recipient watcher 214b to the message router component 304. The message router component 304 is configured to send notify messages to the presence protocol layer component 306 included in the server 202.

In another aspect, sending the notify message includes formatting the notify message to a format compatible with a presence protocol. For example, the presence protocol layer component 306 can be configured for formatting the notify message to a format compatible with a presence protocol. After formatting the notify message, the presence protocol layer component 306 passes the notify message to the network protocol stack 308 along with the network address of the second device 206b of the recipient watcher 214b. The network protocol stack 308 can provide protocol headers and trailers as determined by the various layers of the protocol stack and transmit the notify message via the network 208 to the second device 206b.

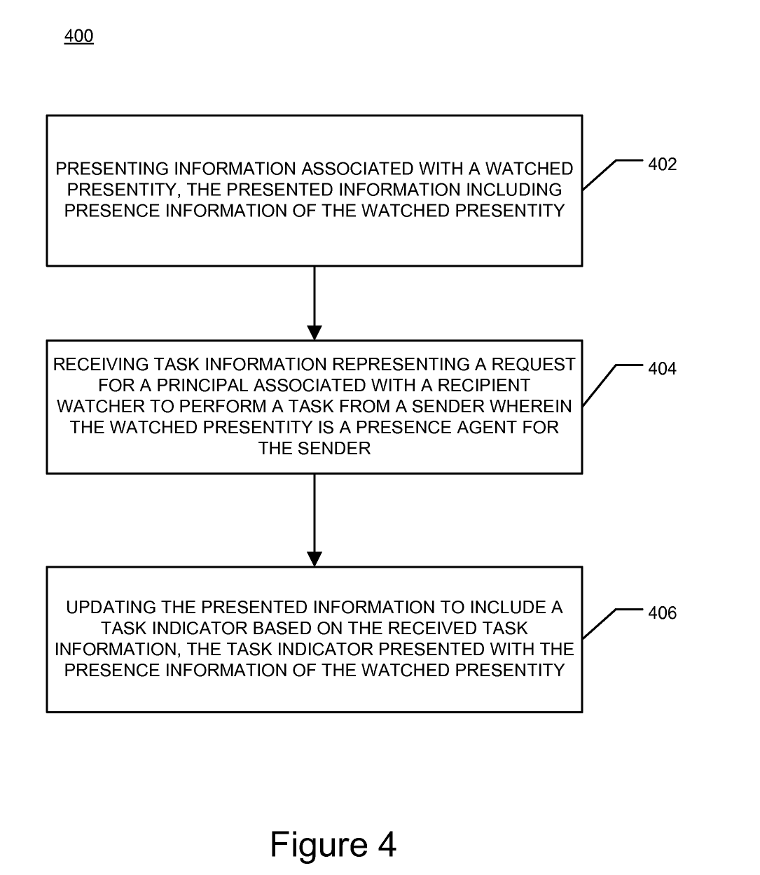

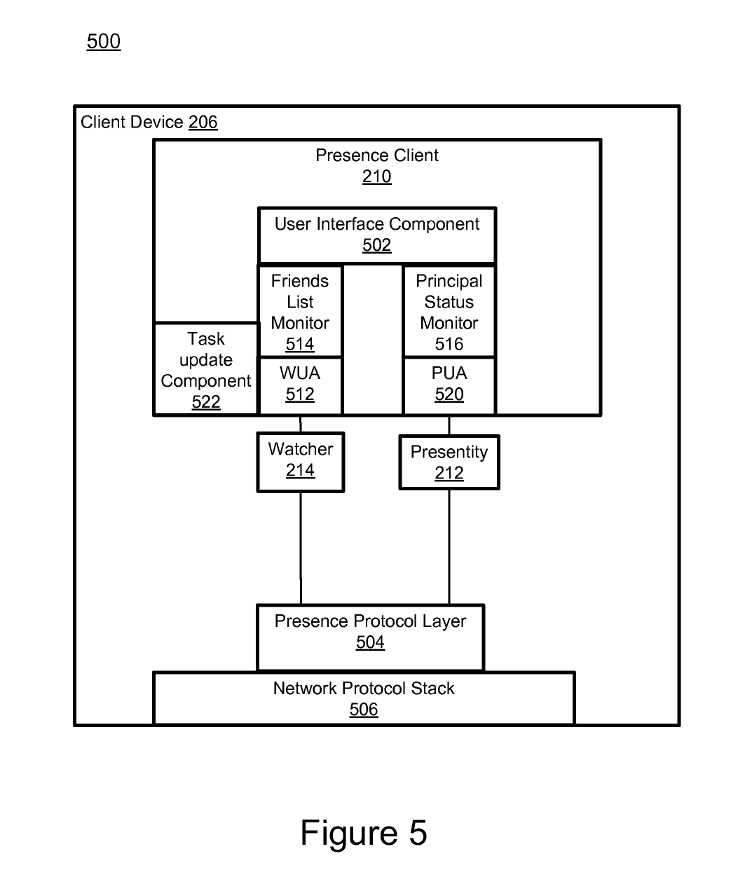

FIG. 4 is a flow diagram illustrating a method for communicating task information according to an exemplary embodiment of the subject matter described herein. FIG. 5 is a block diagram illustrating a system for communicating task information according to another exemplary embodiment of the subject matter described herein. The method illustrated in FIG. 4 can be carried out by, for example, some or all of the components illustrated in the exemplary system of FIG. 5. The method and system illustrated in FIG. 4 and FIG. 5 are from the perspective of a device including a presence client. For example, the second device 206b can carry out the method while receiving the notify message from the server 202 as described above.

With reference to FIG. 4, in block 402 information associated with a watched presentity is presented. The presented information includes presence information of the watched presentity. Accordingly, a system for communicating task information includes means for presenting information associated with a watched presentity. The presented information includes presence information of the watched presentity. For example, as illustrated in FIG. 5, a user interface component 502 is configured for presenting information associated with a watched presentity, the presented information including presence information of the watched presentity.

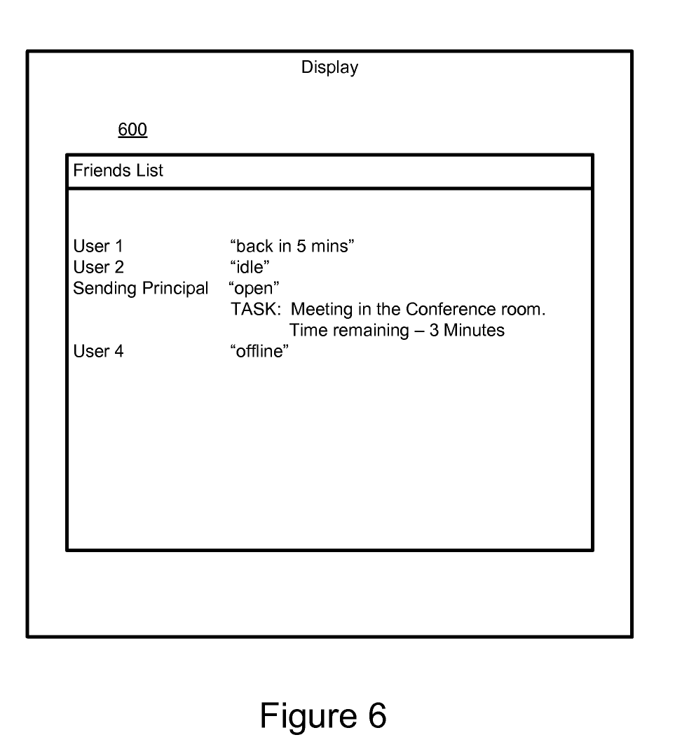

The system 500 in FIG. 5 depicts the device 206 including the presence client 210 in greater detail. The device 206 can be either the first device 206a or the second device 206b. In the system 500, a user interface is presented by the device 206 by a user interface component 502 included in the presence client 210. According to an aspect, the user interface can be a graphical user interface (GUI). For example, FIG. 6 illustrates an exemplary GUI 600 associated with the presence client 210b of the receiving principal. Presence information associated with four watched presentities (User 1, User 2, the Sending Principal, and User 4) is presented. The information displayed for each watched presentity includes a presence identifier such as “User 1” and a status, such as “back in 5 minutes”. This presence information can be received earlier in notify messages from the presence service 204. Notify messages including the presence information are received by the watcher 214 included in the device 206 via a presence protocol layer 504 and a network protocol stack 506. The watcher 214 can communicate with the presence service 204 on behalf of the presence client 210. The watcher 214 can interact with a watcher user agent (WUA) 512 for a client. The watcher 214 can translate requests between the presence protocol of the presence service 204 and the data format used by the watcher user agent component 512. The watcher user agent component 512, according to an aspect, can translate in a similar manner to a watcher. The watcher user agent component 512 translates between a data format known to the watcher 214 and a user of the watcher user agent component 512, such as a friends list monitor 514 described below. If the formats are the same data format, the watcher user agent component 512 can function as a message router or can provide an interface to the presence service for subscribing and receiving notifications.

As discussed above, the watcher 214 receives the notify messages from the presence service 204 through the presence protocol layer 504. The presence protocol layer 504 receives the messages via the network protocol stack 506 included in the operating environment of the client device 206. The watcher 214 routes the messages to the watcher user agent component 512 within the presence client 210. According to an aspect, the watcher user agent component 512 can be configured to format the presence information and make it available to the user interface component 502 for presentation to the principal associated with the presence client 210.

Returning to FIG. 4, in block 404 a notify message including task information representing a request for a principal associated with a recipient watcher to perform a task is received from a sender. The watched presentity is a presence agent of the sender. Accordingly, a system for communicating task information includes means for receiving a notify message including task information representing a request for a principal associated with a recipient watcher to perform a task from a sender. The watched presentity is a presence agent of the sender. For example, as illustrated in FIG. 2 and FIG. 5, a watcher component 214 is configured for receiving a notify message including task information representing a request for a principal associated with a recipient watcher to perform a task from a sender. The watched presentity is a presence agent of the sender.

In the system 500, the watcher 214 in the client device 206 receives a notify message including task information representing a request from a sender for a principal associated with a recipient watcher to perform a task. For example, the notify message, including the task information, can be received from the presence server 202 though the network protocol stack 504 and the presence protocol layer 506 as described above for the notify messages containing presence information. The presence server 202 can generate and send the notify message as described above.

In another aspect, receiving a notify message including task information includes formatting the received task information to a format presentable by a user interface. For example, the watcher user agent component 512 can be configured for formatting the received task information to a format presentable by a user interface. As with the notify messages containing presence information described above, the notify messages containing task information are routed from the watcher 214 to the watcher user agent component 512 and to a friends list monitor 514 that can process and store the information in the received notify message, including the task information. The friends list monitor 514 can make the information in the received notify message available for use by the user interface component 502.

Returning to FIG. 4, in block 406 the presented information is updated to include a task indicator based on the received task information, the task indicator presented with the presence information of the watched presentity. Accordingly, a system for communicating task information includes means for updating the presented information to include a task indicator based on the received task information. The task indicator presented with the presence information of the watched presentity. For example, as illustrated in FIG. 4, the user interface component 502 is configured for updating the presented information to include a task indicator based on the received task information. The task indicator is presented with the presence information of the watched presentity.

The user interface component 502 can receive an indication from the friends list monitor 514 of the received task information. In response, the user interface component 502 can update the user interface to present a task indicator based on the task information along with the presence information of the watched presentity. The task indicator can be presented in a variety of manners including displaying the task indicator visually, presenting the task indicator audibly, and presenting the task indicator in other manners. For example, the user interface component 502 can be a graphical user interface component configured to display status information associated with a friends list and additionally present task information where a task is displayed in association with a “friend” whose presentity sent the publish message including the task information.

The user interface component 502 presents the task indicator in a manner that associates it with presence information from the sender presentity 212a of the sending principal. For example, user interface component 502 can display a GUI, as illustrated in FIG. 6, showing the Sending Principal's presence ID “Sending Principal”, his/her status, and the message, “Meeting in the conference room.” As discussed above, FIG. 6 shows a sample GUI for the receiving principal. The task information (“Meeting in the Conference Room”) was sent by the Sending Principal (the watched presentity in this example) and a task indicator based on the task information is displayed directly under the status information for the sending principal. The task indicator could also be displayed in other manners such as in a separate area in the display that listed all received tasks. In that case, the presence ID of the watched presentity (e.g., “Sending Principal”) can be included with the task information so the user can know that this task is from Sending Principal.

In another aspect, the task indicator can include a selectable link associated with the task information. For example, the user interface component 502 can be configured for presenting the selectable link associated with the task information. A link associated with the task information allows the principal associated with the recipient watcher to select the link and be directed to a resource that is usable in accomplishing at least a portion of the task. The task information can be formatted in Hypertext Markup Language (HTML) and include hyperlinks.

In another aspect, when the task information includes time information representing a time period associated with the task, the task indicator can include a representation of the time period associated with the task. For example, the user interface component 502 can be configured for presenting the time period. FIG. 6 illustrates an exemplary GUI that displays a time period of “3 Minutes” remaining for the task. According to an aspect, the task indicator can be deleted in response to an expiration of the time period. For example, the user interface component 502 can be configured for deleting the task indication in response to the expiration of the time period. In the example illustrated in FIG. 6, the task indicator “TASK: Meeting in the Conference room” can be deleted after the remaining time period of thee minutes elapses.

Once a task has been presented, a plurality of actions can be taken with regard to the task. According to an aspect, task update information representing an update to the task identified with the task information can be received by the client from the principal associated with the client. The task update information can represent at least one of accepting the task, rejecting the task, and completing the task. For example, a task update component 522 can be configured for receiving input representing task update information representing an update to the task identified with the task information. Once a task has been completed, for example, the receiving principal can indicate the completion of the task by inputting task update information representing the completion to the task. In another aspect, the task indicator includes a user interface input control, such as a selectable button, for generating task update information. For example, the user interface component 502 can be configured for presenting a selectable button for generating task update information. A “complete” button can be presented for example. Once the “complete” button is selected, task update information representing completing the task is generated.

The task update information can be sent to a presence server for updating a tuple associated with the task information in response to receiving the task update information. For example, the network protocol stack component 506 can be configured for transmitting the task update information to a presence server for updating a tuple associated with the task information in response to receiving the task update information.

According to an aspect, task update information representing an update to the task identified with the task information can be received by the server 202. In response to receiving the task update information, a tuple associated with the task information can be updated. For example, the message router component 304 can be configured for receiving task update information representing an update to the task identified with the task information. The publication handler component 302 can be configured for updating a tuple associated with the task information in response to receiving the task update information.

According to another aspect, a status of the recipient can be updated in response to receiving the task information. For example, a principal status monitor component 516 can be configured for updating a status of the recipient in response to receiving the task information. When a task is received, the watcher user agent component 512 can analyze the task and, based on the elements in the task, invoke the principal status monitor component 516 to automatically update the recipient's presence status. For example, upon receiving a task from a manager, the status of a user could be changed to “busy.” The Presence User Agent (PUA) 520 can be used by the presence client to publish updates to presence information for the associated principal.

Tasks can be automatically handled upon being received. A task can be auto accepted or auto rejected upon being received. According to another aspect, principal information representing the ability of the principal to perform the task can be received. Task update information is automatically generated in response to the received principal information. For example, the principal status monitor component 516 can be configured for receiving principal information representing the ability of the principal to perform the task. After the principal information is received, the task update component 522 can be configured for generating task update information in response to the received principal information.

For example, a task can be auto accepted or auto rejected based on existing calendar entries and tasks of the principal associated with the recipient watcher. When a task is received by the watcher user agent component 512, the task can be automatically handled based on a variety of factors. An analysis of current calendar entries can be performed to determine the availability of the principal to perform the task. If a task is received with a deadline of one hour and the user's calendar shows that the user is in a meeting during that hour, then the task could be automatically rejected. An analysis of current tasks can be performed in addition or alternatively. If the principal has three urgent tasks with deadlines within the next hour and a low priority task is received with a deadline within the next hour, then the low priority task could be automatically rejected. An analysis of the received task could be performed to determine the availability of the principal to perform the task. For example, if an analysis of the received task determines that the task is from the recipient's manager, then the task could automatically be accepted.

According to an aspect, a request to forward the task to a second recipient can be received by the client device 206 from the principal associated with the client device 206. A notify message including task information representing a request for a principal associated with a second recipient watcher to perform a task can be transmitted to a device associated with the second recipient watcher. The task update component 522 can be configured for receiving a request to forward the task to a second recipient. The network protocol stack component 506 can be configured for transmitting a notify message, including task information representing a request for a principal associated with a second recipient watcher to perform a task, to a device associated with the second recipient watcher. A task entry can be forwarded/delegated to another user. A user input control, such as a “forward” button, can be provided for use in receiving a request to forward the task. Upon receiving a selection of the “forward” button, a destination field popup can be displayed for receiving an address/identifier for forwarding the task. A publish message can be sent to the server to update the task tuple and change the recipient.

It should be understood that the various components illustrated in the various block diagrams represent logical components that are configured to perform the functionality described herein and can be implemented in software, hardware, or a combination of the two. Moreover, some or all of these logical components can be combined, some can be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11 (a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention can be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for communicating task information, the method comprising:
receiving a publish message including task information representing a request for a principal associated with a recipient watcher to perform a task, the publish message associated with the recipient watcher and a sender presentity;
generating a notify message addressed to a device associated with the recipient watcher, the notify message based on the task information and including a sender presentity identifier; and
sending the notify message to the device associated with the recipient watcher enabling the task information to be presented with presence information associated with the sender presentity.

2. The method of claim 1 wherein the task information includes at least one of a task identifier representing a predefined task and a text string representing a task.

3. The method of claim 1 wherein the task information includes time information representing a time period associated with the task, and wherein the method includes:
updating a tuple associated with the task information in response to an expiration of the time period.

4. The method of claim 1 including:
updating at least one of a presence tuple associated with the sender and a friends list tuple associated with the sender in response to receiving the publish message.

5. The method of claim 1 including:
generating a task tuple in response to receiving the publish message, the task tuple including a sender element, a recipient element, and a task information element.

6. The method of claim 1 wherein the received publish message is a directed publish message and a notify message is generated in response to receiving the directed publish message.

7. The method of claim 1 wherein generating a notify message includes identifying address information for the device associated with the recipient watcher.

8. The method of claim 1 wherein sending the notify message includes formatting the notify message to a format compatible with a presence protocol.

9. The method of claim 1 including:
receiving task update information representing an update to the task identified with the task information; and
updating a tuple associated with the task information in response to receiving the task update information.

10. A method for communicating task information, the method comprising:
presenting information associated with a watched presentity, the presented information including presence information of the watched presentity;
receiving a notify message including task information representing a request for a principal associated with a recipient watcher to perform a task from a sender, wherein the watched presentity is a presence agent of the sender; and
updating the presented information to include a task indicator based on the received task information, the task indicator presented with the presence information of the watched presentity.

11. The method of claim 10 wherein receiving a notify message including task information includes formatting the received task information to a format presentable by a user interface.

12. The method of claim 10 wherein the task indicator includes a selectable link associated with the task information.

13. The method of claim 10 wherein the task information includes time information representing a time period associated with the task and the task indicator includes a representation of the time period associated with the task.

14. The method of claim 13 including deleting the task indicator in response to an expiration of the time period.

15. The method of claim 10 including receiving input representing task update information representing an update to the task identified with the task information.

16. The method of claim 15 including sending the task update information to a presence server for updating a tuple associated with the task information in response to receiving the task update information.

17. The method of claim 15 wherein the task indicator includes a user interface input control for generating task update information.

18. The method of claim 15 wherein the task update information represents at least one accepting the task, rejecting the task, and completing the task.

19. The method of claim 10 including updating a status of the recipient in response to receiving the task information.

20. The method of claim 10 including:
receiving a request to forward the task to a second recipient; and
transmitting a notify message including task information representing a request for a principal associated with a second recipient watcher to perform a task to a device associated with the second recipient watcher.

21. The method of claim 10 including:
receiving principal information representing the ability of the principal to perform the task; and
automatically generating task update information in response to the received principal information.

22. A system for communicating task information, the system comprising:
means for receiving a publish message including task information representing a request for a principal associated with a recipient watcher to perform a task, the publish message associated with the recipient watcher and a sender presentity;
means for generating a notify message addressed to a device associated with the recipient watcher, the notify message based on the task information and including a sender presentity identifier; and
means for sending the notify message to the device associated with the recipient watcher enabling the task information to be presented with presence information associated with the sender presentity.

23. A system for communicating task information, the system comprising:
a publication handler component configured for receiving a publish message including task information representing a request for a principal associated with a recipient watcher to perform a task, the publish message associated with the recipient watcher and a sender presentity;
a notification handler component configured for generating a notify message addressed to a device associated with the recipient watcher, the notify message based on the task information and including a sender presentity identifier; and
a message router component configured for sending the notify message to the device associated with the recipient watcher enabling the task information to be presented with presence information associated with the sender presentity.

24. The system of claim 23 wherein the task information includes time information representing a time period associated with the task, and wherein the publication handler component is configured for updating a tuple associated with the task information in response to an expiration of the time period.

25. The system of claim 23 wherein the publication handler component is configured for updating at least one of a presence tuple associated with the sender and a friends list tuple associated with the sender in response to receiving the publish message.

26. The system of claim 23 wherein the publication handler component is configured for generating a task tuple in response to receiving the publish message, the task tuple including a sender element, a recipient element, and a task information element.

27. The system of claim 26 including a subscription handler component configured for subscribing the recipient to the generated task tuple.

28. The system of claim 23 wherein the notification handler component is configured for identifying address information for the device associated with the recipient watcher.

29. The system of claim 23 including a presence protocol layer component configured for formatting the notify message to a format compatible with a presence protocol.

30. The system of claim 23 wherein:
the message router component is configured for receiving task update information representing an update to the task identified with the task information; and
the publication handler component is configured for updating a tuple associated with the task information in response to receiving the task update information.

31. A system for communicating task information, the system comprising:
means for presenting information associated with a watched presentity, the presented information including presence information of the watched presentity;
means for receiving a notify message including task information representing a request for a principal associated with a recipient watcher to perform a task from a sender, wherein the watched presentity is a presence agent of the sender; and
means for updating the presented information to include a task indicator based on the received task information, the task indicator presented with the presence information of the watched presentity.

32. A system for communicating task information, the system comprising:
a user interface component configured for presenting information associated with a watched presentity, the presented information including presence information of the watched presentity;
a watcher component configured for receiving a notify message including task information representing a request for a principal associated with a recipient watcher to perform a task from a sender, wherein the watched presentity is a presence agent of the sender; and
the user interface component further configured for updating the presented information to include a task indicator based on the received task information, the task indicator presented with the presence information of the watched presentity.

33. The system of claim 32 including a watcher user agent component configured for formatting the received task information to a format presentable by a user interface.

34. The system of claim 32 wherein the task indicator includes a selectable link associated with the task information and the user interface component is configured for presenting the selectable link associated with the task information.

35. The system of claim 32 wherein the task information includes time information representing a time period associated with the task and the user interface component is configured for presenting a representation of the time period associated with the task.

36. The system of claim 35 wherein the user interface component is configured for deleting the task indicator in response to an expiration of the time period.

37. The system of claim 32 including a task update component is configured for receiving input representing task update information representing an update to the task identified with the task information.

38. The system of claim 37 including a network protocol stack component configured for transmitting the task update information to a presence server for updating a tuple associated with the task information in response to receiving the task update information.

39. The system of claim 37 wherein the wherein the user interface component is configured for presenting a user interface input control for generating task update information.

40. The system of claim 32 including a principal status monitor component configured for updating a status of the recipient in response to receiving the task information.

41. The system of claim 32 including a task update component is configured for receiving a request to forward the task to a second recipient; and the system includes:
a network protocol stack component configured for transmitting a notify message including task information representing a request for a principal associated with a second recipient watcher to perform a task to a device associated with the second recipient watcher.

42. The system of claim 32 including:
a principal status monitor configured for receiving principal information representing the ability of the principal to perform the task; and
a task update component configured for generating task update information in response to the received principal information.

43. The system of claim 32 wherein the user interface component includes a graphical user interface component configured for displaying the task indicator with the presence information of the watched presentity.

44. A computer readable medium including a computer program, executable by a machine, for communicating task information, the computer program comprising executable instructions for:
receiving a publish message including task information representing a request for a principal associated with a recipient watcher to perform a task, the publish message associated with the recipient watcher and a sender presentity;
generating a notify message addressed to a device associated with the recipient watcher, the notify message based on the task information and including a sender presentity identifier; and
sending the notify message to the device associated with the recipient watcher enabling the task information to be presented with presence information associated with the sender presentity.

45. A computer readable medium including a computer program, executable by a machine, for communicating task information, the computer program comprising executable instructions for:
presenting information associated with a watched presentity, the presented information including presence information of the watched presentity;
receiving a notify message including task information representing a request for a principal associated with a recipient watcher to perform a task from a sender, wherein the watched presentity is a presence agent of the sender; and
updating the presented information to include a task indicator based on the received task information, the task indicator presented with the presence information of the watched presentity.
